(19) United States
(12) Patent Application Publication
(10) Pub. No.: US 2014/0357337 A1
(43) Pub. Date: Dec. 4, 2014

(54) DUAL HAND WAGERING GAME WITH SECONDARY WAGERS

(71) Applicant: Pockaj D.O.O. (d.b.a Alfastreet), Kozina (SI)

(72) Inventor: Iztok Pockaj, Lokev (SI)

(73) Assignee: Pockaj D.O.O. (d.b.a Alfastreet), Kozina (SI)

(21) Appl. No.: 14/293,883

(22) Filed: Jun. 2, 2014

Related U.S. Application Data
(60) Provisional application No. 61/829,935, filed on May 31, 2013.

(51) Int. Cl. G07F 17/32

(52) U.S. Cl. CPC G07F 17/3293; G07F 17/3244
USPC 463/13

(57) ABSTRACT

The invention is directed to a method of providing a dual hand wagering game on a display device including a controller. The method comprises the steps of: receiving a wagering selection of at least one of a plurality of wagering options, wherein the wagering options are associated with either one or both of a first card and a second card; randomly generating the first card and the second card for display on the display device from at least one standard deck of playing cards; comparing the randomly generated first and second cards with a preset wager winning criteria; and awarding a payout responsive to the wagering selection received matching the preset wager winning criteria satisfied.

### CROSS REFERENCE TO RELATED APPLICATIONS

This application claims priority to U.S. Provisional Application No. 61/829,935 entitled DUAL HAND WAGERING GAME WITH SECONDARY WAGERS, filed on May 31, 2013, the entirety of which is incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND

Many new games are quickly rising in popularity because they provide numerous wagering opportunities, thus increasing player participation and excitement. Consequently, new wagering games and further variations of existing wagering games are always of interest to players and casinos.

Current card wagering games are limited in their ability to provide multiple wagering opportunities. Many games now are limited to one main wager surrounding the primary game rules. This limits not only the ability of the one player actively participating in the game, but also prevents additional players from placing bets on the same card game that is currently at play.

Furthermore, current games lack sufficient secondary wager options during gameplay. This decreases the excitement and interaction that the players can have with the game.

Thus, there is a need for systems and methods which resolve one or more of the problems identified above, among other things.

### SUMMARY OF INVENTION

The invention is directed to systems and methods of providing a wagering game in which two hands of one or more playing cards each are generated for comparison against each other and secondary game criteria for determining side wager outcomes.

Some embodiments of the invention are directed to a method of providing a dual hand wagering game on a display device including a controller. The controller is configured to display the play of a wagering game, a plurality of playing cards, and wagering options on a display device. The method comprises the steps of: receiving a wagering selection of at least one of a plurality of wagering options, wherein the wagering options are associated with either one or both of a first card and a second card; randomly generating the first card and the second card for display on the display device from at least one standard deck of playing cards; comparing the randomly generated first and second cards with a preset wager winning criteria, wherein the preset wager winning criteria includes either the first card outranking the second card, the second card outranking the first card, one or both of the first card and second cards being a suit selected from the group of diamonds, clubs, hearts or spades, one or both of the first and second cards being within a first predefined subset of cards, one or both of the first and second cards being within a second predefined subset of cards; and awarding a payout responsive to the wagering selection received matching the preset wager winning criteria satisfied.

Some embodiments of the invention are directed to a method of providing a dual hand wagering game as a live table game including a gaming table. The method comprises the steps of: providing at least one randomly-ordered deck of physical playing cards; receiving a wagering selection of at least one of a plurality of wagering options, wherein the wagering options is associated with either one or both of a first physical playing card and a second physical playing card drawn from the at least one randomly-ordered deck of physical playing cards; distributing the first physical playing card and the second physical playing card from the at least one randomly-ordered deck of physical playing cards for display on the gaming table; comparing the first and second physical playing cards with a preset wager winning criteria, wherein the preset wager winning criteria includes either the first physical playing card outranking the second physical playing card, the second physical playing card outranking the first physical playing card, one or both of the first physical playing card and second physical playing card being a suit selected from the group of diamonds, clubs, hearts or spades, one or both of the first physical playing card and second physical playing card being within a first predefined subset of physical playing cards, one or both of the first physical playing card and second physical playing card being within a second predefined subset of physical playing cards, wherein the first and second subsets include different cards, one or both of the first physical playing card and second physical playing card being within a third predefined subset of physical playing cards, one or both of the first physical playing card and second physical playing card being within a fourth predefined subset of physical playing cards, wherein the third and fourth subsets include different physical playing cards; and awarding a payout responsive to the wagering selection received matching the preset wager winning criteria satisfied.

Finally, some embodiments of the invention are directed to a non-transitory information recording medium on which a computer readable program is recorded that causes a computer to function as a method of providing a dual hand wagering game on a display device including a controller. The controller is configured to display the play of a wagering game, a plurality of playing cards, and wagering options on a display device. The method comprises the steps of: receiving a wagering selection of at least one of a plurality of wagering options, wherein the wagering options are associated with either one or both of a first card and a second card; randomly generating the first card and the second card for display on the display device from at least one standard deck of playing cards; comparing the randomly generated first and second cards with a preset wager winning criteria, wherein the preset wager winning criteria includes either the first card outranking the second card, the second card outranking the first card, one or both of the first card and second cards being a suit selected from the group of diamonds, clubs, hearts or spades, one or both of the first and second cards being within a first predefined subset of cards, one or both of the first and second cards being within a second predefined subset of cards; and awarding a payout responsive to the wagering selection received matching the preset wager winning criteria satisfied.

### BRIEF DESCRIPTION OF THE DRAWINGS

Other advantages of the invention will be readily appreciated as the same becomes better understood by reference to the following detailed description when considered in connection with the accompanying drawings:

FIG. 1a is a front view of a game station constructed and configured according to an embodiment of the invention;

FIG. 1b is a side view of a game station constructed and configured according to an embodiment of the invention;

FIG. 1c is a top view of a game station constructed and configured according to an embodiment of the invention;

FIG. 2 is a schematic view of a game controller that may be used with the game station shown in FIG. 1;

FIG. 2 is a schematic representation of an exemplary system utilizing the game stations and interacting with the dual hand wagering game;

FIG. 4 is a process flow chart illustrating an exemplary method of implementing the dual hand game with secondary wagers;

FIG. 5 an illustration of the game display layout with the plurality of wager options;

FIG. 6 is an illustrative table of the wager options available within an embodiment of the present game;

FIG. 7-9 display various embodiments of the game station utilized to display the game; and

FIGS. 10-13 illustrate various embodiments of the game display according to the industrial application of the present invention.

### DETAILED DESCRIPTION OF INVENTION

The exemplary embodiments herein relate to various systems and methods using in gaming applications.

Some embodiments of the invention are directed to systems and methods of providing a wagering game in which two hands of one or more playing cards each are generated for comparison against each other and secondary game criteria for determining side wager outcomes.

For example, in one embodiment, the game involves receiving a primary wager that either one of a first hand or a second hand will outrank the other, and receiving a wager on a secondary game for one or both of the first or second hands, wherein the secondary game is determined by comparing the secondary game criteria to the cards in either the first or second hand depending on the hand on which the side wager is placed.

For example, the secondary wager criteria may relate to the suit of the first or second hand (hearts, spades, clubs or diamonds), the rank of the first or second hand such as whether it is above or below a certain rank or number (such as 1-6 or 8-13), the color of the suit of the first or second hand (either red or black), whether the hand is odd or even (converting the ace into the number one, and the jack, queen, king cards into numbers eleven, twelve and thirteen, respectively), or whether the first and second hand have the same rank.

In some embodiments, the wager on the secondary game is only won if the primary wager is also won, whereas in other embodiments the secondary wager is determined independently of the primary wager. In some embodiments, a commission is charged to play the game. In some embodiments, one or more of the secondary wagers are mandatory.

In some embodiments, game outcome is determined using a program with a random number generator to simulate one or more decks of cards. In other embodiments, at least one randomly ordered deck of physical playing cards is used.

Some embodiments of the invention are directed to a system for conducting the wagering games as described herein. The system may include a device or apparatus, such as processor or randomly ordered decks of playing cards, for randomly generating playing cards in the underlying game for the first and second hands. The system may also include a processor configured for determining the final outcome of the underlying game according its rules, wherein the final outcome may be a first hand win, a second hand win or a tie hand, and comparing the final outcome with a secondary game criteria, wherein the secondary game criteria includes a first or second hand card rank, color, suit or number which may be achieved according to the rules of the underlying game. The system may include an interface for providing a payout corresponding with the wager received if the winning secondary game criteria are satisfied.

The player interface may be a data input and/or data output device or a remote computer terminal, such as a home computer or mobile device with access to local or global network. The system and player interface may be configured for providing the associated wagering game to players via an online system or the Internet. The processor may also be remotely located from the player interface.

In some embodiments, the system further includes a display for presenting the underlying game and the side wagering game. The player interface, processor and display device may be mounted within a unitary housing, and the aforementioned system may be an electronic gaming machine or electronic platform including multiple data input devices providing player positions.

Another exemplary embodiment of the game is described in the accompanying documents and referred to therein as the “Dragon vs. Tiger” game, which is shown as being provided on a computerized platform and facilitated by a player position touch screen display device.

It should be understood that each of the methods and individual steps recited herein may be partially or wholly carried out in a variety of ways and/or systems, which may include, but are not limited to, a live dealer physically dealing playing cards in a casino, an electronic gaming machine (EGM) for one or more players, standalone multiplayer platforms which may include a player interface such as a touchscreen display and a physical or virtual playing cards, through a home computer or portable computing device, such as a tablet computer or mobile phone capable of communicating with a network or over the Internet, global telecommunication network or world wide web.

Some embodiments of the invention are also directed to a non-transitory machine readable media for providing wagering games as described herein including one or more software programs, code and/or data segments as necessary to provide any of the methods described herein on one or more machines. For example, the aforementioned machine readable media may include code and/or data segments for conducting wagering games as described herein.

Those skilled in the art will readily appreciate that the methods described herein may be incorporated in a system in accordance with the invention using virtual representations of table layouts. The system of the invention may include various computer and network related software and hardware, such as programs, operating systems, memory storage devices, data input/output devices, data processors, servers with links to data communication systems, wireless or otherwise, and data transmitting terminals, and may be a standalone device or incorporated in another platform, such as a mobile device. The system of the invention may be provided on electronic platforms with multiple player positions. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein and in the accompanying materials.

Referring to the figures, where like numerals indicate like or corresponding parts throughout the several views, systems and methods of the invention which are configured to cooperate with another in order to provide a bingo game with a roulette feature are described.

### System Generally

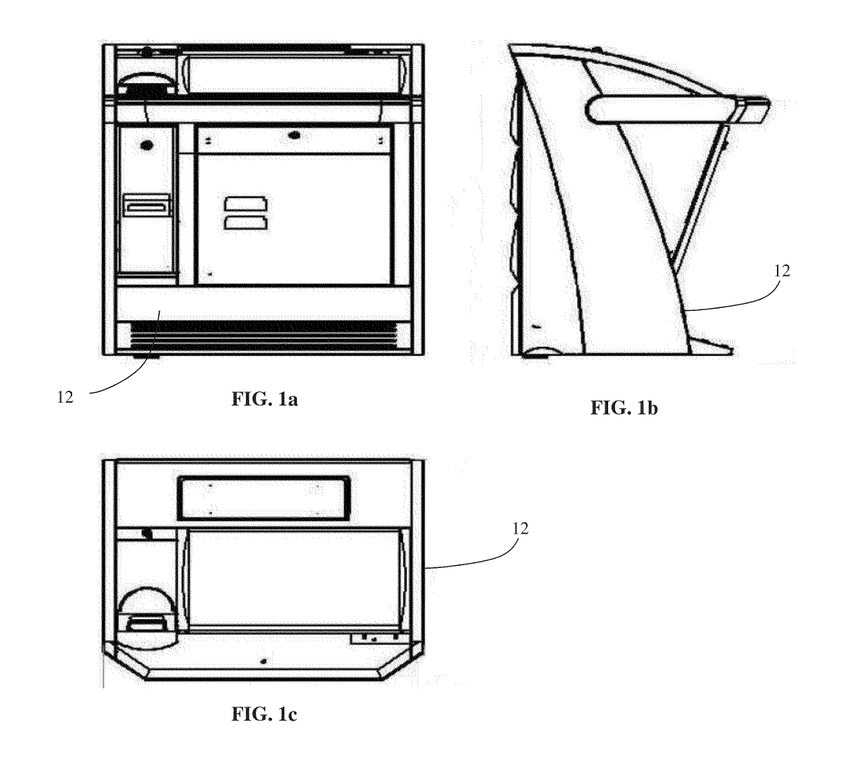

Starting with FIGS. 1a, 1b, 1c, we have three perspective view of a game station 12 used to house the dual hand wagering game of the present invention. The game station includes a display device, a player input device, and a controller configured to display wagering game with a plurality of wager options available for selection. Each wager option is associated with a particular dual card output and a payout responsive to that output. The player input device is in communication with the display device and receives selected wager options, wherein the continued outcomes of the wager options are presented on the display device.

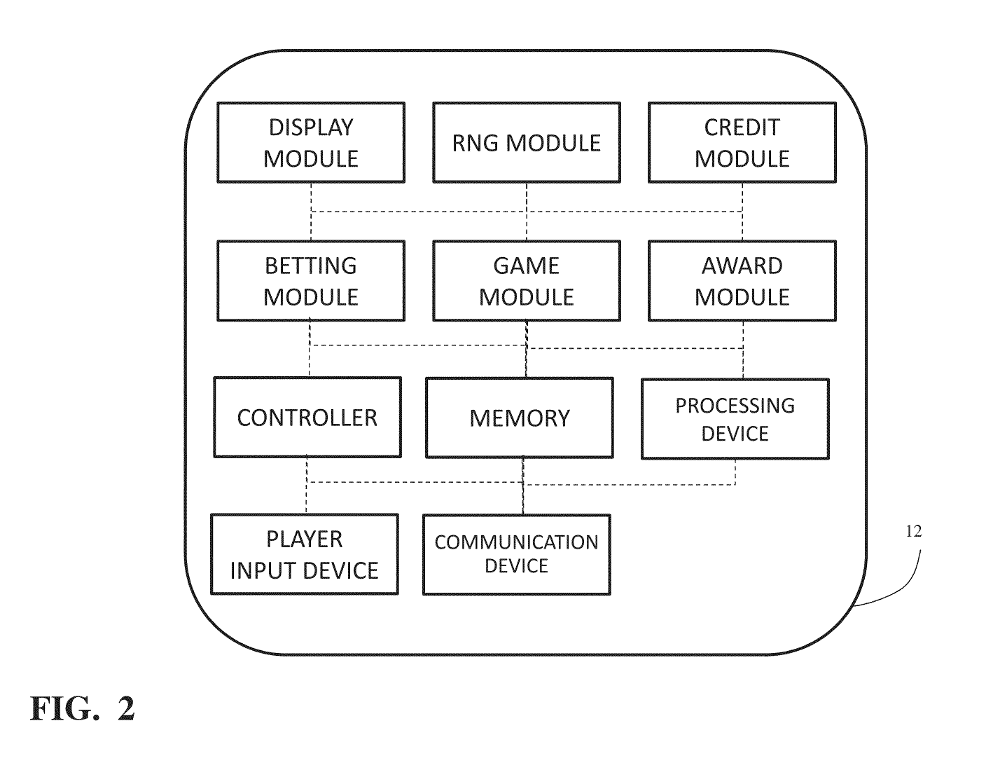

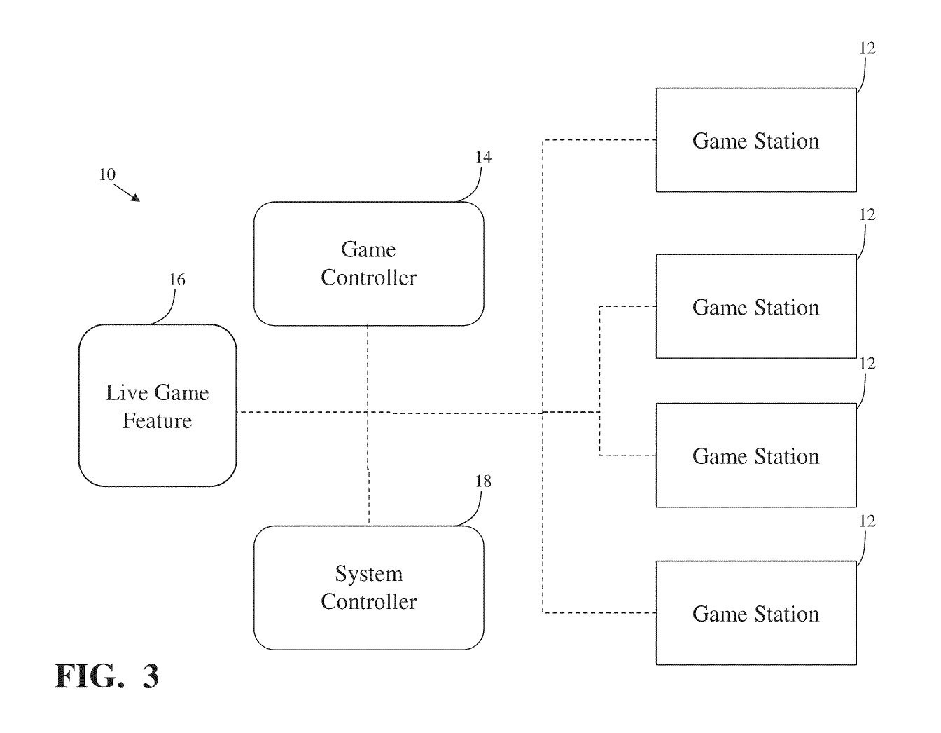

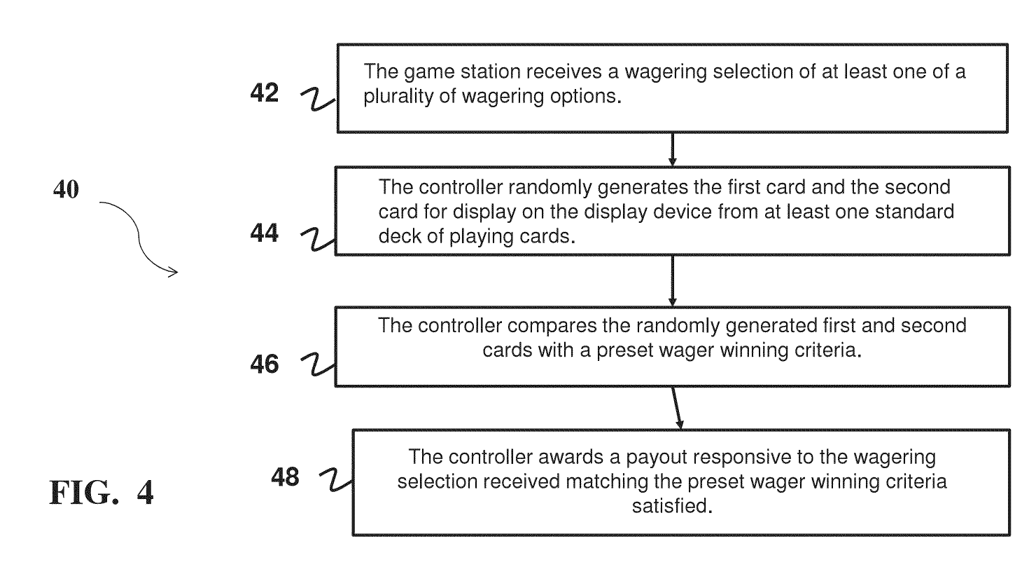

In another embodiment of the present invention, as shown schematically in FIG. 2, the controller within the game station 12 is in further communication with: a display module, a random number generator (RNG) module, a credit module, a betting module, a game module, an award module, memory, a processing device, a player input device, and a communication device in order to implement the dual hand wagering game.

The display module connects with the display devices in order to display the dual hand wagering game during game play. It may also be used to display additional information either from the game station or a connected system 10 depending on the additional requirement of the game operators. The betting module is used to interpret the wager options made by a player during game play, as received through the player input devices on the game station 12.

The RNG module is used to randomly generate the first card and the second card for display on the display device from at least one standard deck of playing cards. The RNG module may be local to the game station 12 or built separately into the system 10 in order to randomly generate the first and second card for display for a plurality of game stations 12. The game module contains the game logic necessary for the continued operation of the game (i.e. game mechanics, payouts, etc.).

The credit module determines the remaining credits available to player in order to continue playing on the game station 12. This may include credits available through the system 10 in communication with the game station 12 or directly available on the game station 12 through the player input device. The award module calculates the payouts based on the current gameplay of the dual hand wagering game as well as additional features present on the game station 12.

The memory present on the game station 12 is used to maintain temporary record of any information regarding the player needed during game play. This may include player tracking information as well as player-based bonus information available to the game station. The processing device further processes actions from the player input device in order to transmit those inputs to the rest of the module within the gaming machine 12.

The player input device included a plurality of player activated buttons fixed to the game station 12 as well as the ticket-in-ticket-out (TITO) mechanism, and currency acceptance mechanism, and the touch-screen component of the display device. All these components together allow for a player to interact with the game station 12.

Finally, the communication device allows for the communication between the game station 12 and the system 10 in order to have multiple game stations 12 interact with each other during game play of a dual hand wagering game (as presented in this invention) or to communicate regarding additional games and features that are built into the system 10 and/or game station 12.

Referring to FIG. 3, the system 10 represents an embodiment of the present dual hand wagering game implemented over a multi-game station setup and comprises one or more game stations 12, a game controller 14 and a live game feature 16. These components may be housed in a unitary housing or remotely positioned with respect to each other, while remaining in communication. Communication between these components may be facilitated by data communication devices connected over a wired or wireless network, using any conventional digital communication devices that are appropriate based on the locations of the system components.

Each of the game stations 12 is used by the players in order to interact with the system and initiate game-play. Game stations 12 can take the form of player positions in a multi-player platform, electronic game machine cabinets or remote kiosks, but are not limited to such designs and may also be provided on smartphones, mobile computing devices, thin terminal devices, non-smartphone-type cellphones, tablets, laptops, or any other device configured to communicate within system 10. In some embodiments, game stations 12 include player input devices, such as keypads and display devices, or touchscreen displays, bill or ticket acceptors and printers, etc. All of the embodiments on the game stations 12 may interact with the system in order to implement the dual hand wagering game as presented in the present invention as well as additional games, presentations, and/or features implemented by the game stations 12 or the system 10.

In another embodiment of the present invention, the system further includes a system controller 18 configured to correlate independent game data with the wager options selected at the at least one game station. This separate system controller 18 may be attached to a live game feature 16 or operate independently in order to manage independent game data needed for a particular game option. The independent game data correlated by the system controller 18 generally related to progressive awards or points, multi-player gaming options utilized by the system, and multi-player gaming mechanics among others.

The controller 14 may include one or more servers, random number generators, programs, databases, memory, data storage devices, data communication devices and data processing devices. Controller 14 is generally configured to manage the operation of dual hand wagering games as described herein by receiving wager options placed through game stations 12, randomly drawing first and second cards, randomly generating the first card and the second card for display on the display device from at least one standard deck of playing cards; comparing the randomly generated first and second cards with a preset wager winning criteria, and awarding a payout responsive to the wagering selection received matching the preset wager winning criteria satisfied. All or some of the components of controller 14 may reside together or be variously integrated into other components of system 10, including game stations 12 and live game feature 16. Controller 14 may also include a security code secured keypad and or touchscreen device for use by authorized personnel.

Method of Implementation for Dual Hand Wagering Game with Secondary Wagers

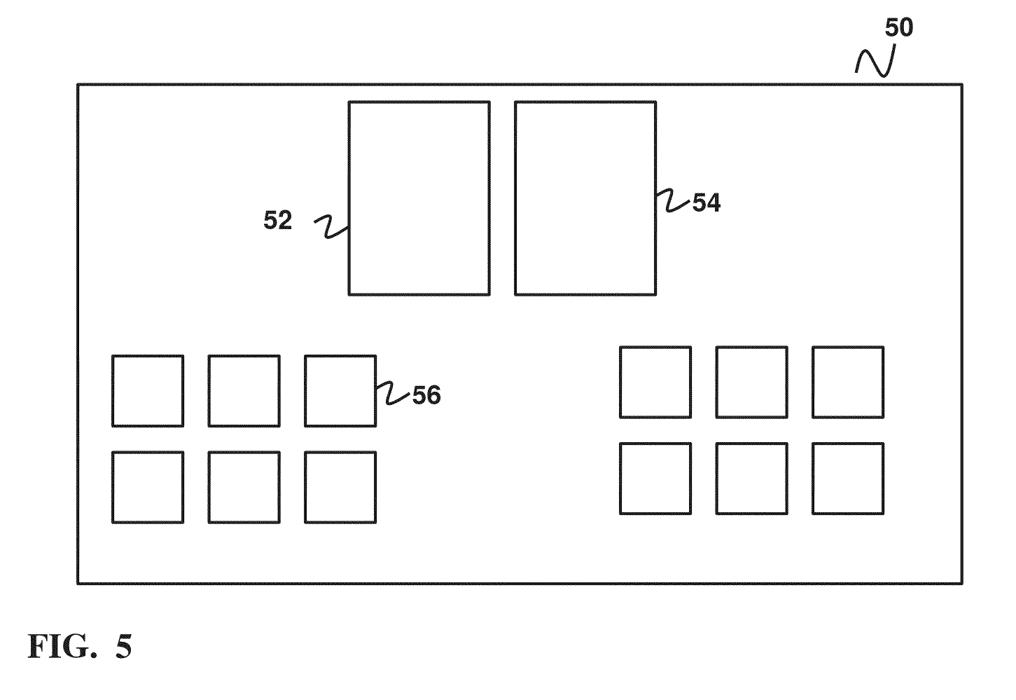

FIG. 5 shows an exemplary method 40 which may be utilized by a game station 12 in order to implement the dual hand wagering game presented in the present invention. This method may also be implemented across system 10 utilizing a plurality of game stations 12, the system controller 18, and the game controller 14.

The method starts with step 42, where the game station receives a wagering selection of at least one of a plurality of wagering options. FIG. 5 is an illustrative layout of the game layout 50 displayed by the display device on the game station 10. The game layout 50 includes a plurality of wager options 56, which a user selects in order to make at least one of a plurality of wager options available at the start of game play. The wager options may differ depending on the desired game mechanics and payouts (discussed in further detail below). Also, the selection of the wager options 56 is exclusive of the type of wager (whether amount wager in form of credits, monetary amount, etc.).

Next, at step 44, the controller randomly generates the first card and the second card for display on the display device from at least one standard deck of playing cards. The first card and the second card may be displayed on the game layout 50 at locations 52 and 54, respectively. These locations are interchangeable and may be dependent on the particular game mechanics of the wagers placed by multiple players of the game at during one game session.

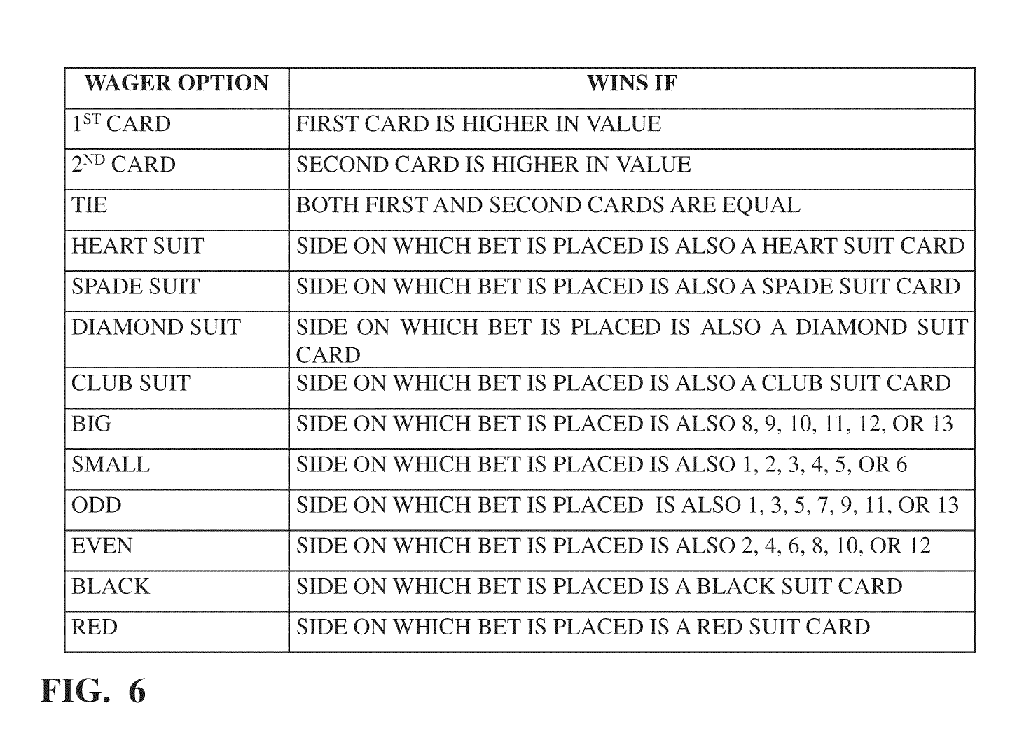

Next, at step 46, the controller compares the randomly generated first and second cards with a preset wager winning criteria. Here, wherein the preset wager winning criteria may include either the first card outranking the second card, the second card outranking the first card, one or both of the first card and second cards being a suit selected from the group of diamonds, clubs, hearts or spades, one or both of the first and second cards being within a first predefined subset of cards, one or both of the first and second cards being within a second predefined subset of cards. The first and second subsets, along with additional subsets discussed later in the application, may be changed depending on the desired game mechanics and wager options desired within the game. FIG. 6 is an illustrative chart of the plurality of subsets available for comparison and association with the wager options 56 displayed by the display device.

Finally, at step 48, the controller awards a payout responsive to the wagering selection received matching the preset wager winning criteria satisfied. This award may be in the form of credits used by the game station 12, the system 10, a game multiplier, or any other type of award utilize throughout game play.

In further embodiments of the present invention, as illustrated in FIG. 6, additional subsets of wager options allows for additional awards based on the comparison between the first card and the second card in addition to additional secondary elements of either cards.

In some embodiments of the present invention, the first and second subsets include different cards. This would include the odd/even and the big/small subsets.

In some embodiments of the present invention, the first and second subsets include a portion of the same cards. This may apply to payouts of secondary wagers in the event of a tie.

In some embodiments of the present invention, the first subset is all even cards, wherein the Queen is even, and the second subset is all odd cards, wherein the Jack and King are odd.

In some embodiments of the present invention, the first subset is all black suited cards and the second subset is all red suited cards.

In some embodiments of the present invention, the preset wager winning criteria further includes one or both of the first and second cards being within a third predefined subset of cards, one or both of the first and second cards being within a fourth predefined subset of cards, wherein the third and fourth subsets include different cards.

In some embodiments of the present invention, the first subset and third subset include a portion of the same cards.

In some embodiments of the present invention, the first subset and third subset include none of the same cards.

In some embodiments of the present invention, the preset wager winning criteria further includes one or both of the first and second cards being within a fifth predefined subset of cards, one or both of the first and second cards being within a sixth predefined subset of cards, wherein the third and fourth subsets include different cards.

In some embodiments of the present invention, the method 40 of providing a dual hand wagering game is implemented as a live table game including a gaming table, comprising the same or similar steps as illustrated in FIG. 5.

In some embodiments of the present invention, the method 40 of providing a dual hand wagering game is implemented a non-transitory information recording medium on which a computer readable program is recorded that causes a computer to function as a game machine for providing a game to a player, comprising the same or similar steps as illustrated in FIG. 5.

### Industrial Application

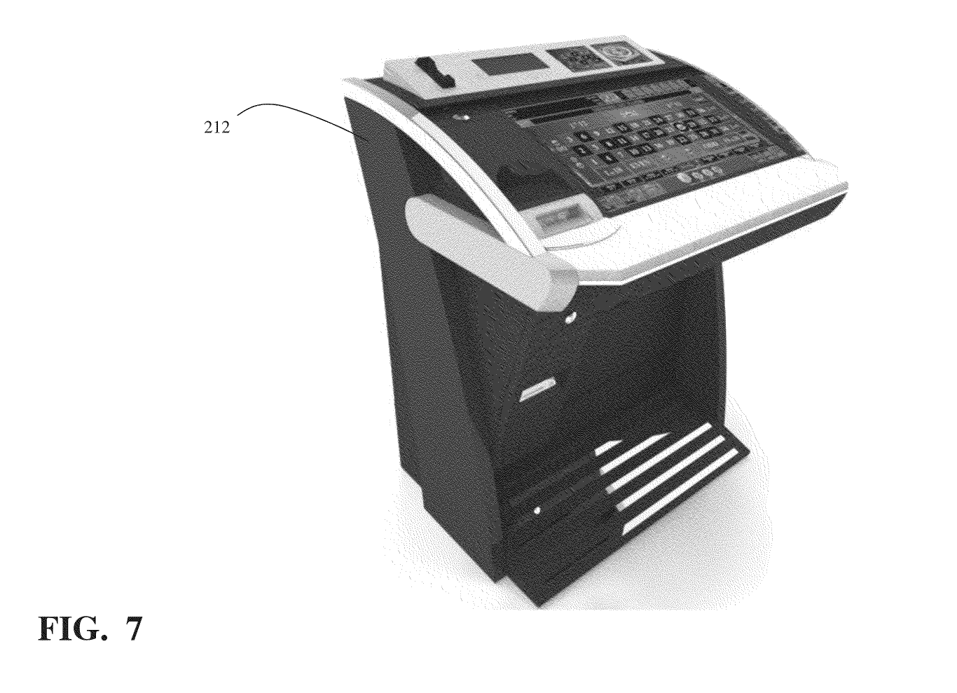

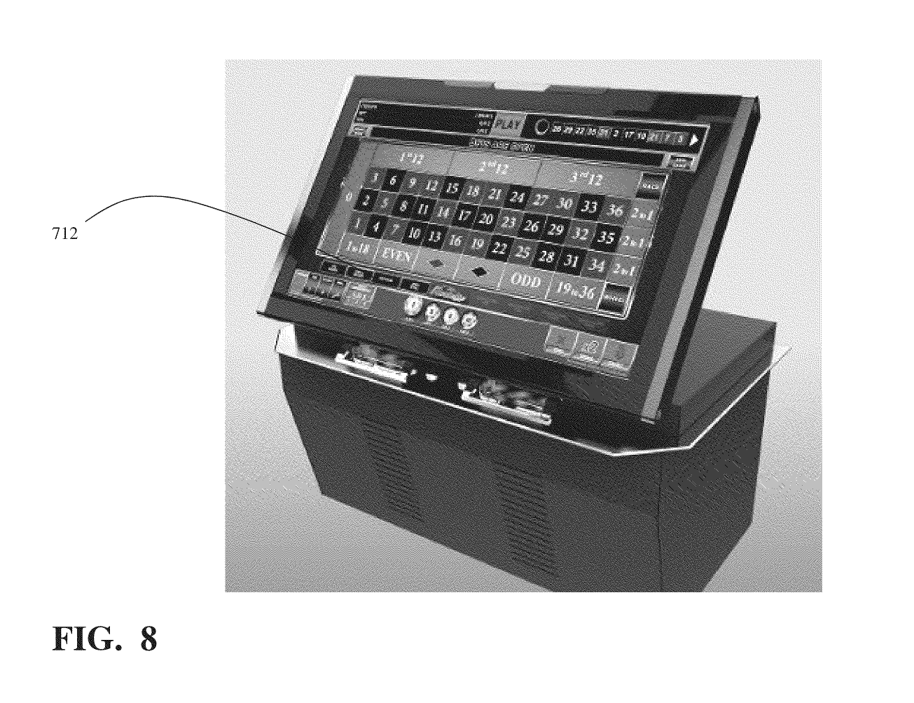

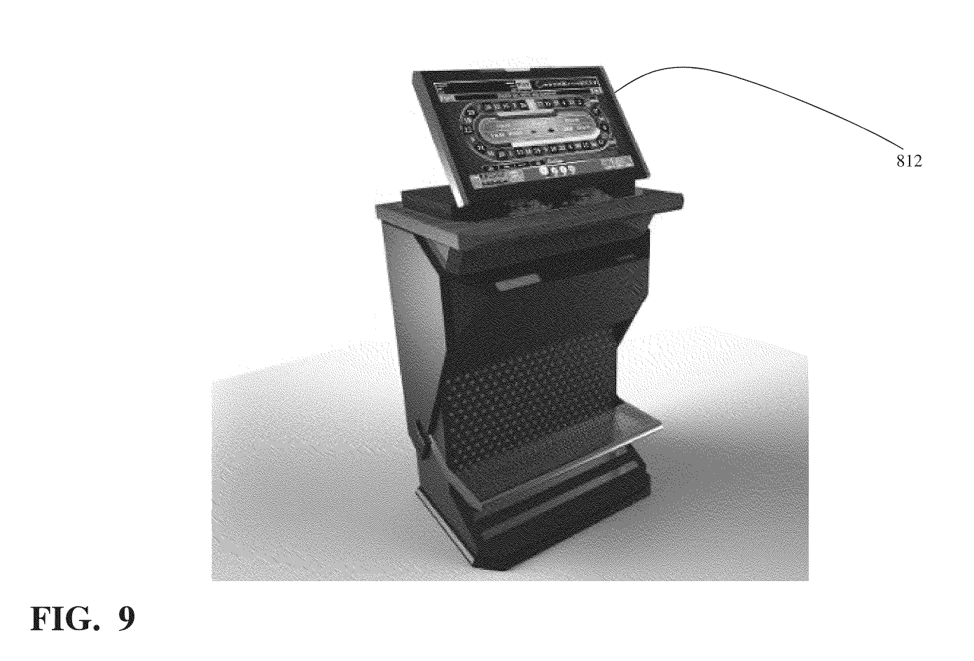

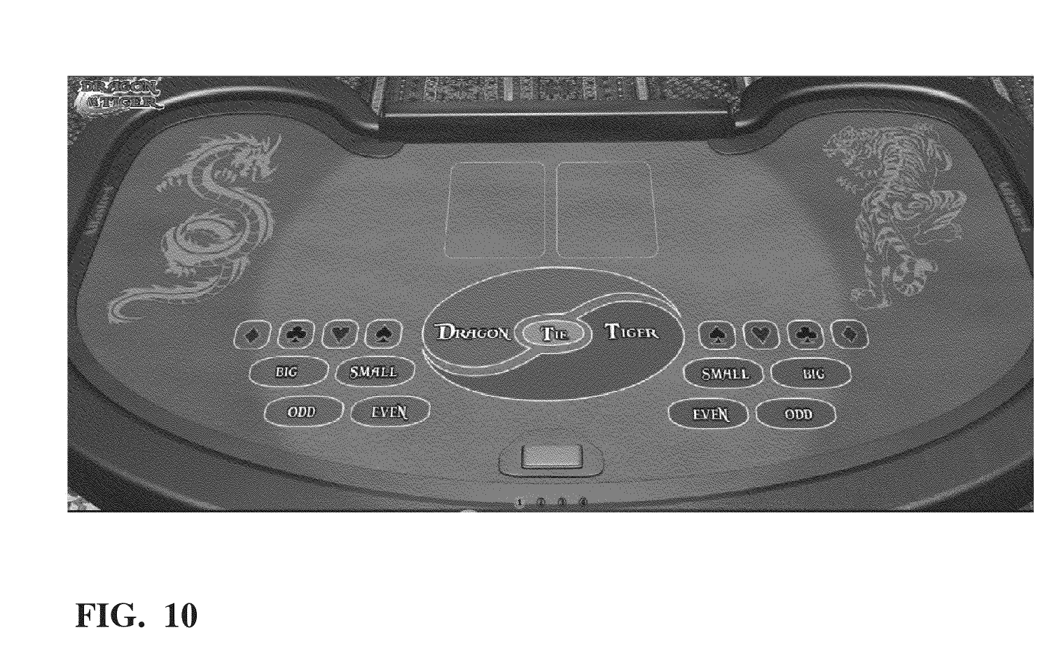

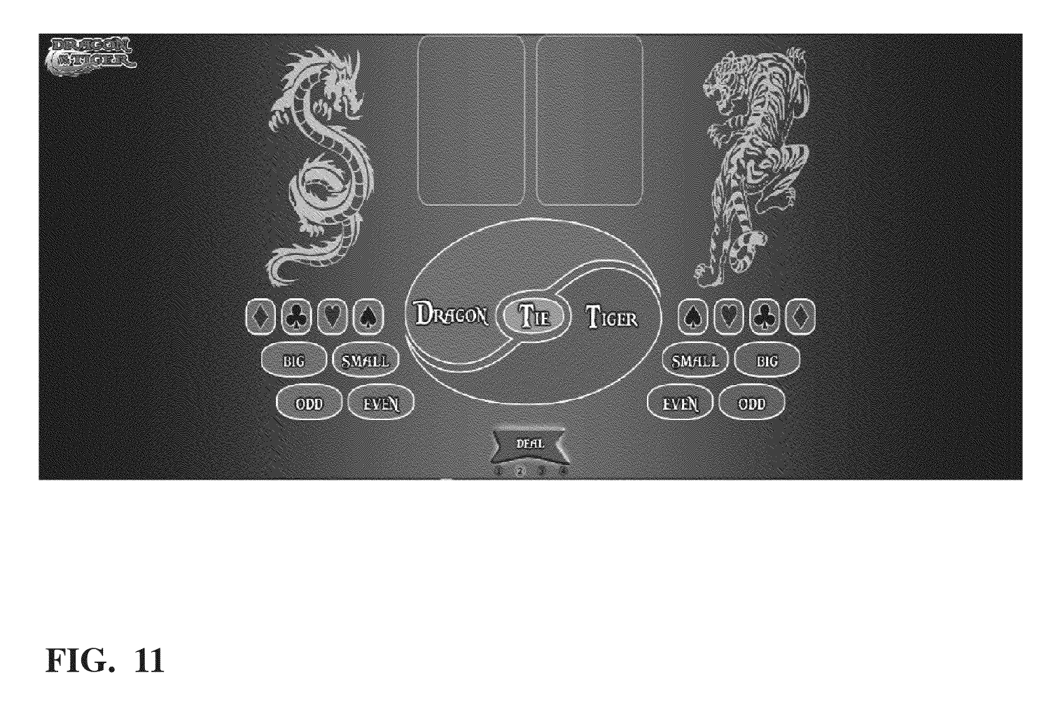

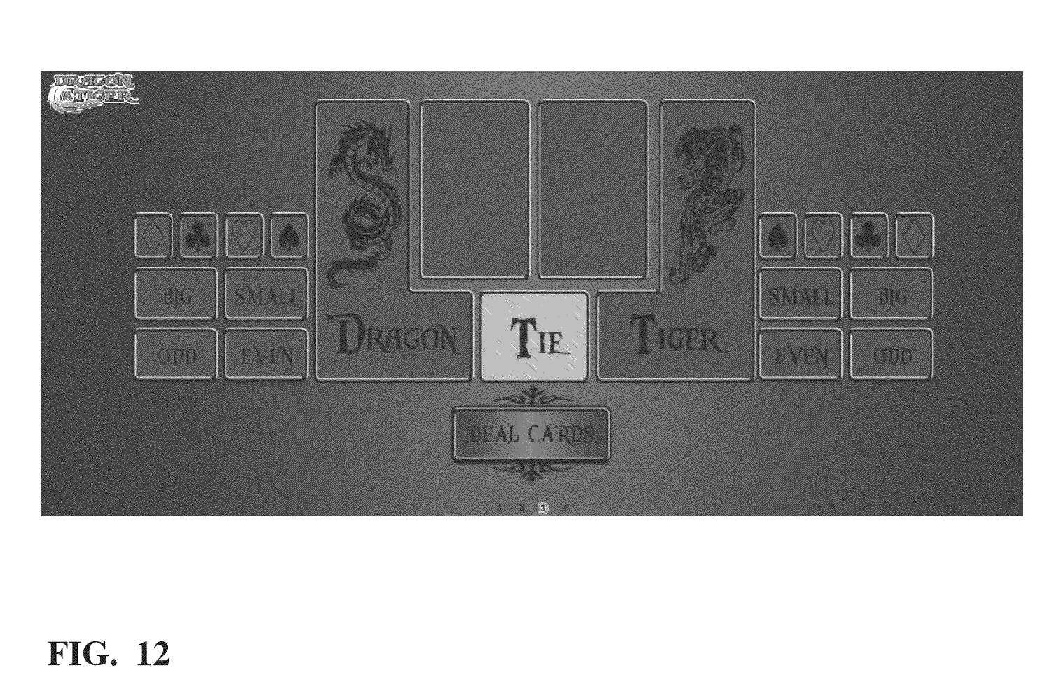

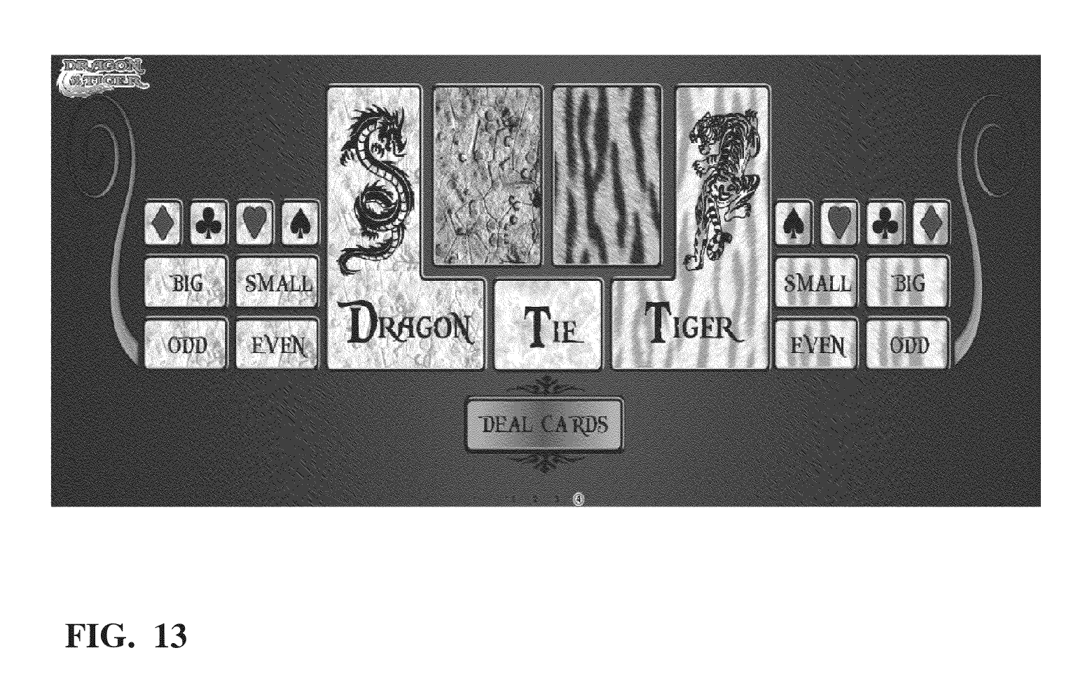

FIGS. 7 through 13 show multiple exemplary embodiments of the invention, including embodiments of game stations and wager option layouts shown through the display device of the game station, which illustrate various industrial applications of the invention, among other things.

### General Considerations

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. The terms used herein, such as modules like display module, betting module, award module, servers, etc., are for ease in describing and illustrating features and operations of the invention and are not to be considered limiting in any way. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary systems and methods in accordance with the invention have been described herein and in the accompanying materials, it should also be understood that the foregoing along with the accompanying materials are illustrative of a few particular embodiments as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as set forth in the claims, including equivalents thereto.

What is claimed is:

1. A method of providing a dual hand wagering game on a display device, including a controller, the controller configured to display the play of a wagering game, a plurality of playing cards and wagering options on a display device, the method comprising the steps of:
receiving a wagering selection of at least one of a plurality of wagering options, wherein the wagering options are associated with either one or both of a first card and a second card;
randomly generating the first card and the second card for display on the display device from at least one standard deck of playing cards;
comparing the randomly generated first and second cards with a preset wager winning criteria, wherein the preset wager winning criteria includes either the first card outranking the second card, the second card outranking the first card, one or both of the first card and second cards being a suit selected from the group of diamonds, clubs, hearts or spades, one or both of the first and second card being within a first predefined subset of cards, one or both of the first and second cards being within a second predefined subset of cards; and
awarding a payout responsive

2. The method, as in claim 1, wherein the first and second subsets include different cards.

3. The method, as in claim 1, wherein the first and second subsets include a portion of the same cards

4. The method, as in claim 1, wherein the first subset is all even cards, wherein the Queen is even, and the second subset is all odd cards, wherein the Jack and King are odd.

5. The method, as in claim 1, wherein the first subset is all black suited cards and the second subset is all red suited cards.

6. The method, as in claim 1, wherein the preset wager winning criteria further includes one or both of the first and second cards being within a third predefined subset of cards, one or both of the first and second cards being within a fourth predefined subset of cards, wherein the third and fourth subsets include different cards.

7. The method, as in claim 6, wherein the first subset and third subset include a portion of the same cards.

8. The method, as in claim 6, wherein the first subset and third subset include none of the same cards.

9. The method, as in claim 1, wherein the preset wager winning criteria further includes one or both of the first and second cards being within a fifth predefined subset of cards, one or both of the first and second card s being within a sixth predefined subset of cards, wherein the third and fourth subsets include different cards.

10. A method of providing a dual hand wagering game as a live table game including a gaming table, comprising the steps of:
providing at least one randomly-ordered deck of physical playing cards.
receiving a wagering selection of at least one of a plurality of wagering options, wherein the wagering options is associated with either one or both of a first physical playing card and a second physical playing card drawn from the at least one randomly-ordered deck of physical playing cards;
distributing the first physical playing card and the second physical playing card from the at least one randomly-ordered deck of physical playing cards for display on the gaming table;
comparing the first and second physical playing cards with a preset wager winning criteria, wherein the preset wager winning criteria includes either the first physical playing card outranking the second physical playing card, the second physical playing card outranking the first physical playing card, one or both of the first physical playing card and second physical playing card being a suit selected from the group of diamonds, clubs, hearts or spades, one or both of the first physical playing card and second physical playing card being within a first predefined subset of physical playing cards, one or both of the first physical playing card and second physical playing card being within a second predefined subset of physical playing cards, wherein the first and second subsets include different cards, one or both of the first physical playing card and second physical playing card being within a third predefined subset of physical playing cards, one or both of the first physical playing card and second physical playing card being within a fourth predefined subset of physical playing cards, wherein the third and fourth subsets include different physical playing cards; and
awarding a payout responsive to the wagering selection received matching the preset wager winning criteria satisfied.

11. A non-transitory information recording medium on which a computer readable program is recorded that causes a computer to function as a game machine for providing a game to a player, comprising:
a controller, the controller configured to display the play of a wagering game, a plurality of playing cards and wagering options on a display device, the controller further configured to:
receive a wagering selection of at least one of a plurality of wagering options, wherein the wagering options are associated with either one or both of a first card and a second card;
randomly generate the first card and the second card for display on the display device from at least one standard deck of playing cards;
compare the randomly generated first and second cards with a preset wager winning criteria, wherein the preset wager winning criteria includes either the first card outranking the second card, the second card outranking the first card, one or both of the first card and second cards being a suit selected from the group of diamonds, clubs, hearts or spades, one or both of the first and second card s being within a first predefined subset of cards, one or both of the first and second cards being within a second predefined subset of cards; and
award a payout responsive to the wagering selection received matching the preset wager winning criteria satisfied.

12. The non-transitory information recording medium, as in claim 11, wherein the controller and display device communicate over a network.

13. The non-transitory information recording medium, as in claim 11, wherein the first and second subsets include a portion of the same cards.

14. The non-transitory information recording medium, as in claim 11, as in claim 11, wherein the first subset is all even cards, wherein the Queen is even, and the second subset is all odd cards, wherein the Jack and King are odd.

15. The non-transitory information recording medium, as in claim 11, wherein the first subset is all black suited cards and the second subset is all red suited cards.

16. The non-transitory information recording medium, as in claim 11, wherein the preset wager winning criteria further includes one or both of the first and second cards being within a third predefined subset of cards, one or both of the first and second cards being within a fourth predefined subset of cards, wherein the third and fourth subsets include different cards.

17. The non-transitory information recording medium, as in claim 16, wherein the first subset and third subset include a portion of the same cards.

18. The non-transitory information recording medium, as in claim 16, wherein the first subset and third subset include none of the same cards.

19. The non-transitory information recording medium, as in claim 11, wherein the preset wager winning criteria further includes one or both of the first and second cards being within a fifth predefined subset of cards, one or both of the first and second card s being within a sixth predefined subset of cards, wherein the third and fourth subsets include different cards.

20. The non-transitory information recording medium, as in claim 11, further comprising a data communication device for receiving the wagering selection.
